(19) United States
(12) Patent Application Publication
(10) Pub. No.: US 2005/0071190 A1
(43) Pub. Date: Mar. 31, 2005

(54) Method and system for patient care triage

(75) Inventors: Lorraine M. Herger, Port Chester, NY (US); Edith Helen Stern, Yorktown Heights, NY (US); Rose Marie Williams, Wappinger Falls, NY (US)

Correspondence Address: Ryan, Mason & Lewis, LLP, 90 Forest Avenue, Locust Valley, NY, 11560, US

(73) Assignee: International Business Machines Corporation, Armonk, NY (US)

(21) Appl. No.: 10/671,985

(22) Filed: Sep. 26, 2003

(51) Int. Cl. G06F 17/60

(52) U.S. Cl. 705/2

(57) ABSTRACT

Techniques for use in accordance with patient care are provided. In one aspect of the invention, a technique for use in accordance with patient care comprises the following steps/operations. One or more metrics associated with one or more patients are received. One or more priorities associated with the one or more patients are determined based at least on the one or more metrics. An ordering of the one or more patients is determined, responsive to the one or more priorities. Responsive to the ordering of the one or more patients, an indicator is transmitted to at least one receiver.

### FIELD OF THE INVENTION

The present invention relates to intelligent notification techniques and, more particularly, to intelligent notification techniques associated with patient care triage, for example, where heterogeneous sensor inputs associated with patients under care are received and used, along with other data, to determine a priority among patients, which is then conveyed to a caregiver.

### BACKGROUND OF THE INVENTION

Healthcare and medical science have made tremendous advances in recent years. Along with impressively increased capability comes impressively difficult “deployment” problems, including increased medical errors. New, effective treatments are being made available at unprecedented high cost. We face complexity, new technologies, and a drive to control resultant costs wherever possible.

A significant factor in rising health care costs is medical error. $17 B is spent on preventable medication errors per year. $76 B is spent on drug interaction related disease and death each year. For every 100 outpatients, there are more than five adverse events, wherein 38% are preventable, and 23% are serious. These statistics come from the 2001 Robert Wood Johnson survey; Kaushal R., Bates D. W., Landrigan C. et al., “Medication Errors and Adverse Drug Events in Pediatric Inpatients,” JAMA Apr. 25, 2001; Institute of Medicine, “To Err is Human,” 1999; Institute of Medicine, “Crossing the Quality Chasm: A New Health System for the 21 st Century,” 2001; and “Achieving the Vision,” Kaiser Permanente, February 2002, the disclosures of which are incorporated by reference herein.

A critical component of patient health care is in-hospital care. Decreased hospital stays permitted by insurance companies and health management organizations (HMOs) result in patients who need to be, on average, more seriously ill to qualify for in-hospital care. Further, nurses have increasingly large workloads of increasingly ill patients. In order to decrease costs, where once a nurse was required to tend to a small number of moderately ill patients, today nurses have workloads of 10 or more seriously ill patients. Many nurses are leaving the profession due to stress, which is the most common reason given for leaving the hospital environment. Along with the increased patient load, nurses must cope with delivering more complicated medical care, e.g., coping with difficult medication regimes, drug interactions, diagnostic procedures, etc.

Furthermore, in healthcare facilities such as hospitals, monitoring stations exist today, with central viewing and alert capability. These stations typically monitor one metric (e.g., heart function) and do not correlate multiple alerts to create a priority. If multiple monitors are available, the measurements may appear in a common physical location on a display screen. However, the measurements are not integrated, nor are personalized instructions available to indicate potential problems.

Thus, there is a need for patient care techniques that allow multiple patients with multiple metrics to be monitored in an intelligent fashion.

### SUMMARY OF THE INVENTION

The present invention provides techniques for use in accordance with patient care.

In one aspect of the invention, a technique for use in accordance with patient care comprises the following steps/operations. One or more metrics associated with one or more patients are received. One or more priorities associated with the one or more patients are determined based at least on the one or more metrics. An ordering of the one or more patients is determined, responsive to the one or more priorities. Responsive to the ordering of the one or more patients, an indicator is transmitted to at least one receiver.

The step/operation of determining one or more priorities may further comprise accessing information about the one or more patients, and evaluating the one or more metrics responsive to the information. The information about the one or more patients may be one or more of medical history, an order of a doctor, a threshold for a metric. The step/operation of determining one or more priorities may further comprise accessing information about a metric. The patient care technique may further comprise the step/operation of determining a receiver for the indicator of order of the one or more patients. The indicator may further comprise recommended care. Further, the step/operation of transmitting an indicator may be performed in a wired manner and/or a wireless manner. The step/operation of transmitting an indicator may comprise transmitting an indicator to multiple receivers.

In another aspect of the invention, the inventive technique may be implemented in accordance with at least one processor and a memory. The at least one processor and the memory may comprise a server.

In yet another aspect of the invention, the inventive technique may be implemented as an article of manufacture for use in accordance with patient care, comprising a machine readable medium containing one or more programs which when executed implement the steps of the inventive technique.

In a further aspect of the invention, a system for use in accordance with patient care comprises one or more input nodes (e.g., patient monitors) for transmitting information associated with one or more patients. The system also comprises at least one server operative to: (i) receive at least a portion of the transmitted information from the one or more input nodes; (ii) determine one or more priorities associated with the one or more patients based at least on the received information; (iii) determine an ordering of the one or more patients, responsive to the one or more priorities; and (iv) responsive to the ordering of the one or more patients, transmit indicator information. The system also comprises one or more output nodes (e.g., devices associated with one or more entities associated with patient care) for receiving at least a portion of the indicator information.

In yet another aspect of the invention, a technique for use in accordance with patient care comprises the following steps/operations. One or more priorities associated with one or more patients are determined. An ordering of the one or more patients is determined, responsive to the one or more priorities. A receiver is determined. Responsive to the ordering of the one or more patients, an indicator is transmitted to the receiver.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating existing caregiver notification systems;

FIG. 2A is a diagram illustrating an information flow associated with a patient care triage methodology according to an embodiment of the invention;

FIG. 2B is a diagram illustrating an intelligent nursing station according to an embodiment of the invention;

FIG. 3 is a flowchart illustrating a patient care triage methodology according to an embodiment of the invention;

FIG. 4 is a flowchart illustrating a process for determining an ordering of patients associated with a patient care triage methodology according to an embodiment of the invention;

FIG. 5 is a flowchart illustrating a process for transmitting an indicator to a notification recipient associated with a patient care triage methodology according to an embodiment of the invention;

FIGS. 6A and 6B are a flowchart illustrating a process for determining a priority associated with a patient care triage methodology according to an embodiment of the invention; and

FIG. 7 is a block diagram illustrating a server for implementing a patient care triage methodology according to an embodiment of the invention.

### DETAILED DESCRIPTION OF PREFERRED EMBODIMENTS

The following description will illustrate the invention using an exemplary patient care triage environment. It should be understood, however, that the invention is not limited to use in any particular patient care-based environment. The invention is instead more generally applicable to any patient care-based environment in which it is desirable to provide intelligent notification.

The invention is targeted to support medical personnel, including nurses, preferably in a care facility, by providing patient care triage. The invention is intended to simplify minute-to-minute triage (e.g., which patient to take care of next) thereby allowing increased workload, as well as reduced stress. The invention provides prioritized intelligent notifications of patients requiring attention to the appropriate personnel, thus allowing nurses to respond to the most important problems first. These notifications are based on heterogeneous events which are correlated, analyzed, and sorted into a triaged list of patients, based on individual medical profiles. Optionally, indications of what care is to be delivered are associated with each patient on the triaged list. The invention therefore reduces medical error, reduces time-to-care for the patient, and reduces stress for the nurses.

Additionally, the invention deals with the fact that patients are often on-the-move within the hospital (e.g., sent for x-rays or other tests), and for outpatient care. The invention can provide a patient priority to a local caregiver (e.g., a nurse at the x-ray station), or a designated caregiver (e.g., a nurse monitoring outpatients). These caregivers have the advantage of the same heterogeneous event correlations and analysis as above.

Further, the invention receives metrics from heterogeneous monitors, analyzes the metrics associated with a given patient and assigns a medical care priority (e.g., if the individual requires immediate care, care soon, no care, or some point in between). The invention determines an ordering among patients assigned to a medical care provider, responsive to the priorities. An indication is provided to the medical personnel of the ordering.

Note that the invention includes the ability to incorporate personalized instructions. Personalized instructions allow more responsive care. For example, this capability would allow a physician to indicate what pulse rate is expected, and what pulse rates are abnormal under a particular physical situation (e.g., medication) for a particular patient. A patient care triage system of the invention can use this profile to adjust the priority of the patient for care.

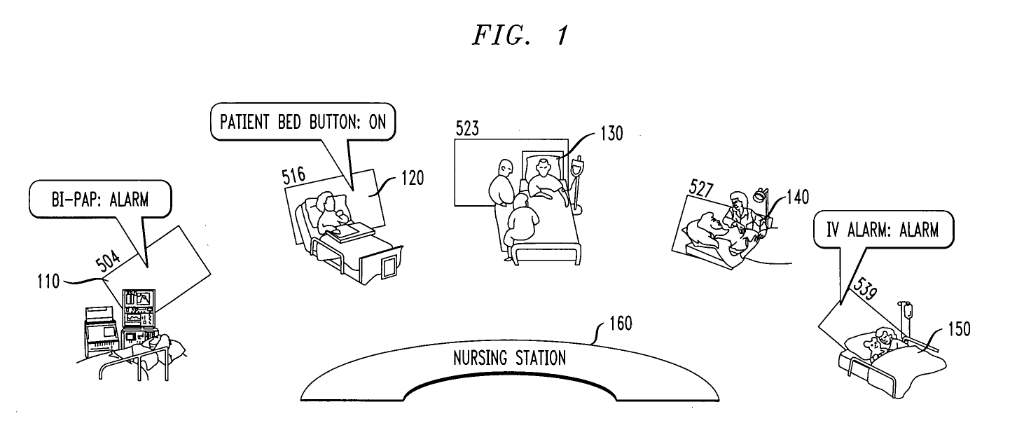

Before describing details of an illustrative patient care triage system and methodology of the invention, some existing caregiver notification systems will be described in the context of FIG. 1.

Referring initially to FIG. 1, a diagram illustrates some existing caregiver notification systems. In FIG. 1, we see five patient rooms, representing the patients for whom a single nurse is responsible in a hospital environment. Patient 110 is in room 504, and has an alarm on his bi-pap machine (bilevel positive airway pressure respirator). Patient 120 is in room 516, and has pressed the call button. Patient 130 is in room 523 with family, and no alert conditions. Patient 140 is in room 527. The nurse is also in room 527 attending to patient 140. Patient 150, a child, in room 539, has an alarm on her IV (intravenous medication delivery unit). The nurses station 160 has monitors that are able to see routine vital signs, such as blood pressure, temperature, oxygen saturation levels, and pulse rate.

In existing systems, some of these patient related indicators or metrics are connected to monitoring instruments. Commonly, the patient call button will cause a visual aid to be operated (e.g., a light by the door of the patient's room). This will also result in a light at the nursing station. If the patient is monitored via a sensor that can transmit data to a central repository, there are systems which will send an e-mail to a physician or group to alert them. Existing systems do not aggregate such sensors nor apply medical rules to determine to whom and at what time an alert should be given.

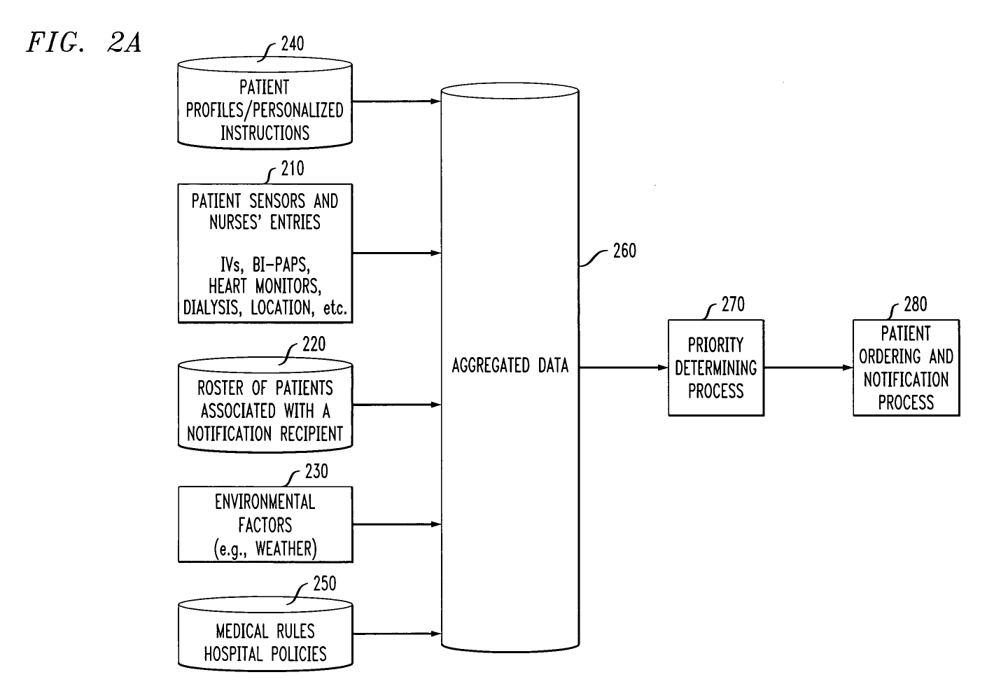

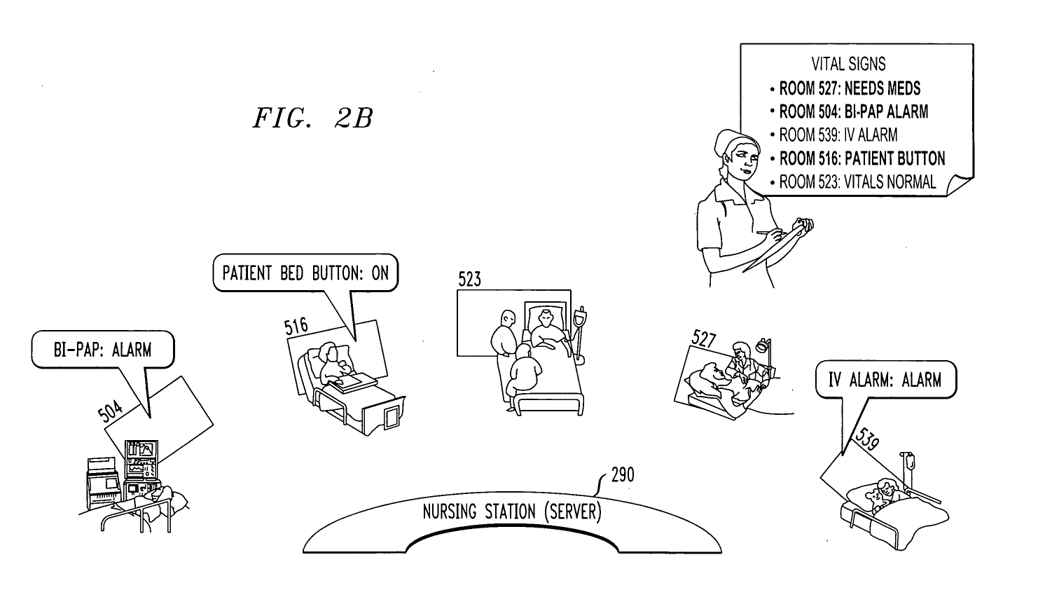

Referring now to FIG. 2A, a diagram illustrates an information flow associated with a patient care triage methodology according to an embodiment of the invention. The elements may be structured, or unstructured, local or connected via a network, including a wireless network. The data within an element may be consolidated, or federated. One or more servers may be employed to implement such elements, and a distributed computing system (e.g., grid) may be employed.

Element 210 represents point of care data associated with a patient, primarily patient metrics. Element 210 includes sources of metrics such as IVs. These units may indicate when the flow of medication or other fluids being administered is compromised. Element 210 includes data from bi-paps, used to assist in breathing. These units may provide metrics of air flow, intake and other information associated with breathing. Most frequently, devices associated with breathing difficulties will provide metrics of oxygen saturation, as a pulse oxymeter. Element 210 may include data from heart monitors, dialysis monitors, and other medical equipment. Element 210 may also include context information associated with the patient, such as patient location (which may be obtained through means well known in the art, such as sensors in a bed and a chair, active radio frequency identification (RFID) tags, global positioning system (GPS) for patients that are outside a care facility, etc.).

Element 210 may also include metrics received from other equipment such as patient call buttons, bed position, toilet operation in patient rooms, and so on. Element 210 represents data associated with an individual patient, or patient associated space (e.g., a hospital bed or room). Metrics may be transmitted in a wired or wireless manner, in a multiplicity of formats. Additionally, element 210 may represent nurse's entries related to the patient (e.g., observations of mental acuity).

In FIG. 2A, it is shown that this information, and information from other system elements, is provided to an aggregation point represented by the disk/database of element 260. One or more of these information flows may be directly provided to the priority determining process element (270) or may be aggregated with other data in a sub-aggregating element.

Element 220 represents the mapping of patients to a notification recipient. That is, this element provides the roster of patients associated with a specific notification recipient. Notification recipients include doctors, nurses, dietitians, physical therapists, and other caregivers. This element provides for changing assignments for caregivers, and can also be used to extend notification to caregivers not normally associated with a caregiving unit, e.g., x-ray technicians. Element 220 may be updated manually, via an administrative entry, or automatically.

In one embodiment, patient location is used to indicate a secondary notification recipient. In one embodiment, if a patient is observed to be in a location distant from his normal position, a secondary notification recipient may be added. In this way, an alarming indication received and processed at a centralized processing system may result in notification of personnel most in position to do something about it. This information, and information from other system elements, is provided to an aggregation point represented by the disk/database of element 260. One or more of these information flows may be directly provided to the priority determining process element (270) or may be aggregated with other data in a sub-aggregating element.

Element 230 represents environmental factors such as temperature, humidity, barometric pressure, terror alert stage/color as pronounced by Homeland Security. This data may be obtained over a network, from a number of sources, including but not limited to, sources accessible over the World Wide Web, from a third party service provider, from a corporate function. These elements are used in determining the importance of a metric. For example, if a patient monitor shows abundance of sweat, then this may be discounted in importance if the temperature is high. If general stress conditions in the environment are present (e.g., recent terrorist attack), this may result in discounted importance placed on blood pressure. This information, and information from other system elements, is provided to an aggregation point represented by the disk/database of element 260. One or more of these information flows may be directly provided to the priority determining process element (270) or may be aggregated with other data in a sub-aggregating element.

Element 240 represents patient profiles and personalized instructions. Patient medical history, recent drugs prescribed and administered, personal preferences of the patient and other historical and preference data is represented by this element. Further, specific instructions by a caregiver such as a physician may also be included. For example, a physician may indicate that she wants to be notified only if the patients temperature exceeds a specific figure, rather than be notified of any temperature exceeding normal. Such personalized rules may be entered to account for expected patient reactions, drug regimes, family history, and so on. That is, standard notification procedures may be overruled by physician entered data, via the inventive system, without need for on-site personnel such as duty nurses to take action. This information, and information from other system elements, is provided to an aggregation point represented by the disk/database of element 260. One or more of these information flows may be directly provided to the priority determining process element (270) or may be aggregated with other data in a sub-aggregating element.

Element 250 represents rules and policies. These will be applied to the patient metrics and other aggregated data to determine a priority for the patient. In addition to the use of medical knowledge to determine the rules by which the system will recognize the need for a notification, hospital policies allow customization for local populations, business policies, and so on. This information, and information from other system elements, is provided to an aggregation point represented by the disk/database of element 260. One or more of these information flows may be directly provided to the priority determining process element (270) or may be aggregated with other data in a sub-aggregating element.

Element 260 represents an aggregation point for data originating elsewhere. Element 260 may be a server, or storage, may be directly or network attached, may be part of the environment or may be provided as a service by a third party. Element 260 is an optional element of the system. Further, note that in a preferred embodiment, data from the other elements is obtained without prior request. In other embodiments, at least one data element is obtained by request to the data element source.

Element 270 represents the priority determining process. This element may be collocated with the IT (information technology) resources of element 210 or may be located elsewhere. The priority determining process may use some or all the data provided, may include estimated values, may perform algorithmic calculations, and may request additional data from one of the preceding sources, or from additional external sources. It may be combined with element 280, the patient ordering and notification process.

Responsive to the priorities determined by element 270, element 280 (the patient ordering and notification process) determines whether an indicator of the patient priority is desirable. This may include determining if a notification is to be sent, and to whom.

Referring now to FIG. 2B, a diagram illustrates a patient care triage system in the form of an intelligent nursing station according to an embodiment of the invention. More particularly, FIG. 2B depicts an embodiment of the invention in action. Patient sensors for vital signs, IVs, call buttons, bi-paps, etc., are integrated into the system. In this scenario, patient 504 has an alarm on his bi-pap machine. Patient 516 has called for the nurse. Patient 539 has an IV alarm. Patient 527 is scheduled for medication. These sensor readings are received by a sensor receiving server, which may make up at least part of the intelligent nursing station 290. The server that is part of the intelligent nursing station 290 also preferably performs the priority determination, patient ordering and indicator transmission operations to be discussed in detail herein. Of course, more than one server may be used to perform such operations.

For each patient, a process for determining a priority analyzes these sensor readings and establishes a priority. Note that the process may use non-sensor data and events to create this priority; for example, time of day, patient profiles, physician orders and other information may be used to create a patient priority.

A second process determines a patient ordering, responsive to the priorities created. This second process, for example, may access data as to what patients are assigned to what nurses, and create the patient ordering from among the patients assigned to that nurse, in priority of attention needed. The ordering is transmitted to the nurse, with the necessary care highlighted. In the example below, the IV alarm and bi-pap alarm are considered red alerts, and are so noted.

As shown, the system has several elements:
(i) Patient sensors, e.g., monitors for heartbeat, blood pressure, IV alarms, etc.
(ii) A sensor server receives the sensor readings, wirelessly or wired (e.g., Ethernet 802.11, wide area network, local area network, cellular network, etc.).
(iii) A priority determining process uses the sensor readings (per patient), uses patient data obtained elsewhere (e.g., from a central patient data store, from doctor's orders, from medical history), uses non-patient data (e.g., rules), to determine a priority.
(iv) A patient ordering process uses patient priority, uses patient assignment data (e.g., which patients to which nurses, which patients physically within nursing distance—this allows patients with wireless monitoring who are in another part of the hospital to receive care locally), uses non-patient data (e.g., rules) to determine an ordering.
(v) A mechanism for indicating ordering, for example, a mobile device or other data receiver on which patient ordering and priorities can be displayed. Indicators may be transmitted to the receiver wirelessly or wired (e.g., Ethernet 802.11, wide area network, local area network, cellular network, etc.). The system may have multiple receivers.

Optionally, patient triage data may be provided to a local nurse. That is, when patients are not in his room (e.g., sent for x-rays), they are assigned a local nurse as a caregiver. This may be done through administrative action, or automatically via knowledge of patient location and doctor's orders. While the patients are physically absent, although sensor data may be received at a central sensor receiving server, the triage information may be sent to the local caregiver. This extension allows for outpatient care, with in-hospital monitoring and triage. The triage information may also be sent to a physician.

In a preferred embodiment, the sensors are wirelessly connected to a network. The sensor server receives some sensor readings, and polls for others over a population of patients. This population may be determined via database, or via proximity (e.g., the sensors that are available within communication range determine the population). Software within the server evaluates the data, and associates the data with a patient. The process further obtains information about the patient from a patient database, and obtains other pertinent information such as rules and hospital policy. The information is evaluated and a priority is assigned. For a population of caregivers, patients are grouped by caregiver and priorities indicated. If a change in priority is noted, the updated priority list is transmitted to a mobile device carried by the caregiver.

The flow charts and corresponding descriptions to follow will present steps in preferred sequences. However, it is to be understood that the invention is not limited to the ordering of steps as shown. That is, the principles of the invention may be realized via alternate step sequences.

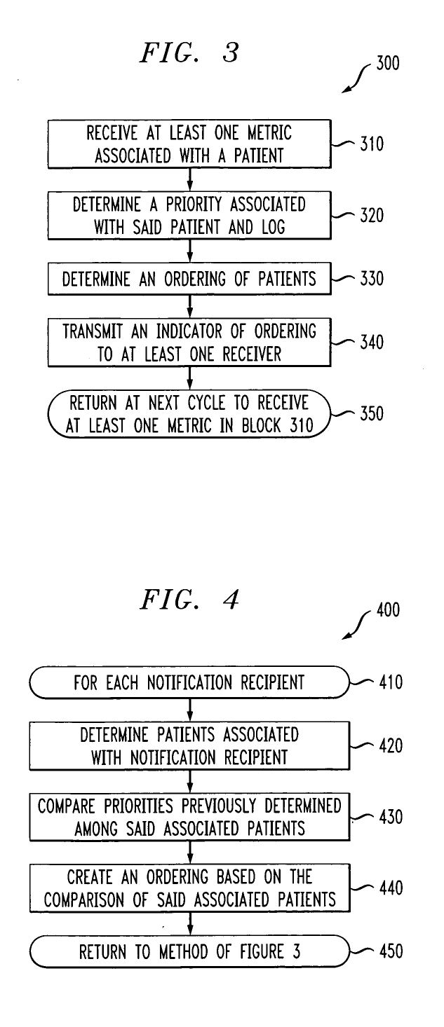

Referring now to FIG. 3, a flowchart illustrates a patient care triage methodology according to an embodiment of the invention. Methodology 300 begins with step 310. In step 310, the methodology receives at least one metric associated with at least one patient. This metric may be received through a wired or wireless network. The metrics may represent numerical medical information, e.g., oxygen saturation levels from a pulse oxymeter, blood pressure measurements, or patient temperature. The metrics may represent a measurement taken at specific time intervals, or measurements reported by local monitoring equipment only upon passing a threshold. Therefore, such metrics may represent expected or unexpected conditions.

Further, metrics received in step 310 may indicate operation of equipment associated with the patient, e.g., flow of IV fluids through an IV station, error conditions associated with such machinery. Other metrics received in step 310 include patient context information. Patient context information includes, but is not limited to, location, scheduled appointments, and calendar information. In addition, metrics received in step 310 include metrics received from sensors associated with the patient (e.g., room temperature for the hospital room, indications of toilet use, television use, patient call button use, bed position).

Once the metric is received in step 310, the methodology proceeds to step 320 and determines a priority associated with the patient. The priority may be determined through examination of the at least one metric received, or through analysis of this metric in association with other aggregated data. The other data includes other metrics associated with this patient, as well as information about this patient including, but not limited to, patient profiles, patient medical history, doctor's orders on this patient, patient drug regimens, patient dietary intake, patient preferences.

Further, the other data may include, but is not limited to, hospital policies, medical rules for analysis, history of patients with similar medical problems, and environmental information which may include, but is not limited to, weather, politics, terror alert levels, smog levels, barometric temperature. Analysis includes, but is not limited to, exercising medical rules in conjunction with hospital policies, evaluating metrics indicative of a critical need for response independent of other data, comparing metrics to expected metrics, where such expected metrics are obtained locally or remotely, including from a web site (e.g., a pharmaceutical companies drug web site indicating expected physiological reactions to specific dosages).

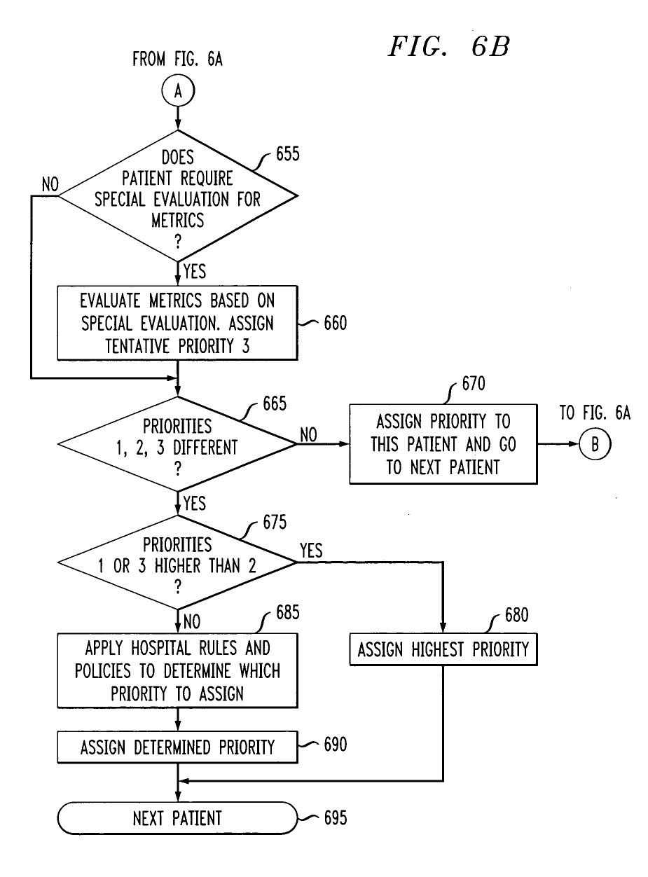

The priority determined for the patient may be of greater or lesser granularity. In one embodiment, priorities may be determined to be low, medium, or high care required. In a preferred embodiment, such priorities may be assigned numerical values, letter values, or other symbolic values. Further detail on determining a priority will be presented in FIGS. 6A and 6B.

Different priorities may result from the application of different rules. That is, a priority responsive to standard medical rules may be different than that determined by taking into account a patient's diagnosis and medical history. Further, doctor's notations may indicate yet a third priority. In a preferred embodiment, when the priorities determined differ, the information is logged for review. The review may be near real time or may occur after the fact. Further, during the evaluation to determine priority, it may be determined that special actions should be taken irrespective of priority. For example, a physician may have requested to be informed when blood pressure exceeds a certain threshold. This threshold may not result in any action to notify a nurse on the floor.

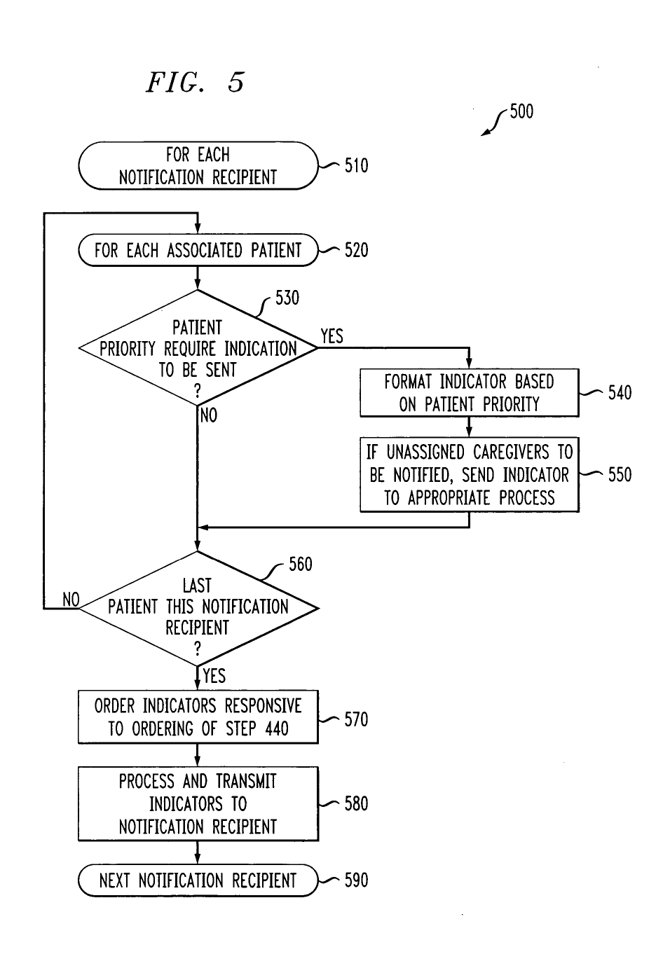

Once a priority has been determined, the methodology proceeds to step 330 in process 300. Here, an ordering of patients is determined. Details of this step are presented in FIG. 4. For each notification recipient, the methodology determines the patients in whom the notification recipient is interested. The methodology then compares the existing priorities previously determined for those patients. Note that these priorities may have been determined at different times. For example, a priority may have just been assigned to one patient, and the remaining patients may be associated with a priority determined some time previous. Since the priorities are determined based on some trigger (e.g., change in patient metric), and since triggers will not occur in near simultaneity for all patients, it is expected that the priorities will be of various ages.

Responsive to the priorities, the methodology then creates an ordering of patients. In a preferred embodiment, this is numerically based, with the highest priority first. The ordering may be based on an algorithm which incorporates the priority. In one embodiment, if priorities are high, medium and low, then patients may be ordered within priorities based on room number or distance to the nurses station. Once an ordering is created, the methodology proceeds to step 340.

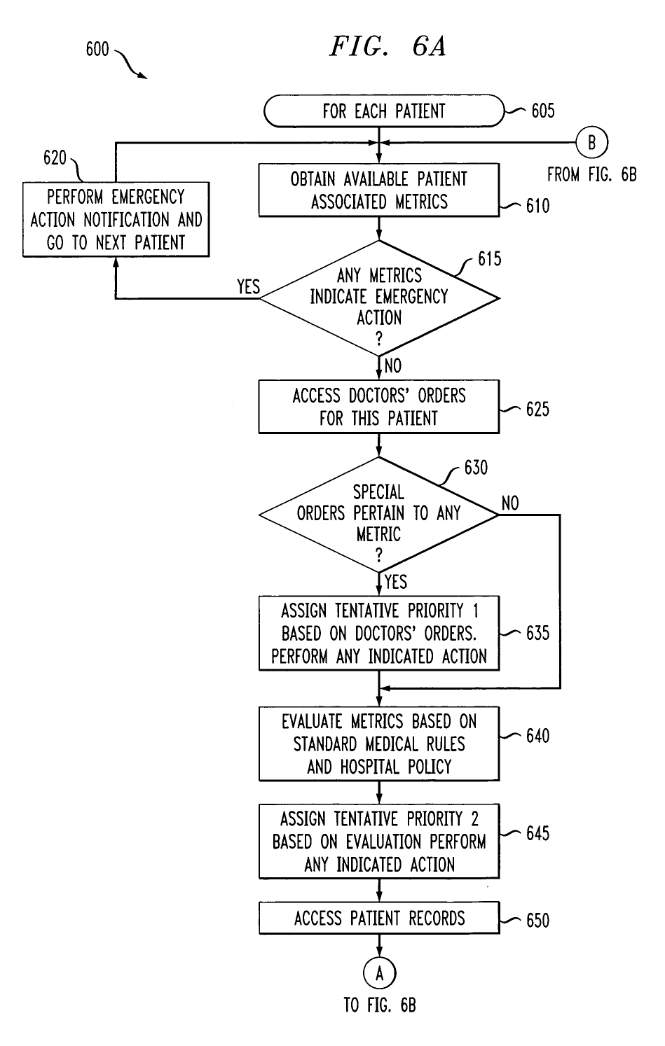

In step 340, the methodology transmits an indicator of the ordering (step 330) to at least one receiver. Further details of step 340 are presented in FIG. 5. Transmitting an indicator includes, but is not limited to, transmitting an ordered list of patients, transmitting a fully formatted screen intended for a specific device, transmitting an audible tone associated with an ordering, transmitting a notification concerning a single patient, or a subset of patients, transmitting an indication to a third party, transmitting an indication to a notification system. At the completion of the step of step 340, the methodology returns to step 310, and continues to receive additional metrics.

Referring now to FIG. 4, a flowchart illustrates a process for determining an ordering of patients associated with a patient care triage methodology according to an embodiment of the invention. More particularly, FIG. 4 provides details of step 330 (FIG. 3). It is to be understood that the steps of process 400 are repeated, as indicated in block 410, for each notification recipient. Notification recipients include, but are not limited to, nurses (e.g., in a hospital), physicians, therapists, residents on duty, technicians (e.g., x-ray technicians), nursing home attendants.

For each notification recipient (NR), in step 420, the process first determines which patients are associated with the NR. In a preferred embodiment, this is determined by at least one of: data from a database, from an algorithm using NR assignment data (e.g., nursing duty assignments and patient room assignments), from patient context such as location (e.g., patient location in an x-ray lab), from patient priority (e.g., head physician notified of all critical emergencies as indicated by patient priorities), from patient data (e.g., patient's primary physician, patient's pulmonologist), by NR specification (e.g., entry by physician).

In step 430, the process compares the priorities for the patients associated with the NR. Note that these priorities may have been determined at different times. For example, a priority may have just been assigned to one patient, and the remaining patients may be associated with a priority determined some time previous. In this step, the process compares the priorities with the associated patients to determine which patients have priorities indicating greater need for immediate care. Each patient may have a unique priority which can be determined to be greater or lesser than all the other NR associated patient priorities, or the priorities may merely allow grouping into groups requiring greater or lesser amounts of immediate care.

The process proceeds to step 440 and creates an ordering based on the comparison of priorities of the patients associated with an NR. In one embodiment, the ordering is numerically based, with the highest priority first. In another preferred embodiment, the ordering is based on an algorithm which incorporates the priority. For example, if priorities are high, medium and low, then patients may be ordered within the priorities based on room number or distance to the nurses station. Step 440 completes process 400, and step 450 represents a return to methodology 300 of FIG. 3.

Referring now to FIG. 5, a flowchart illustrates a process for transmitting an indicator to a notification recipient associated with a patient care triage methodology according to an embodiment of the invention. More particularly, FIG. 5 provides details of step 340 (FIG. 3). It is t be understood that the steps of process 500 are repeated, as indicated in block 510, for each notification recipient. Notification recipients again include, but are not limited to, nurses (e.g., in a hospital), physicians, therapists, residents on duty, technicians (e.g., x-ray technicians), nursing home attendants.

Block 520 indicates that steps 530, 540, 550, 560, 570 and 580 are repeated for each patient associated with a notification recipient (NR). In step 530, the process determines whether the patient priority previously determined requires that an indication is to be sent. This determination may be made via algorithm, such algorithm potentially responsive to, but not limited to, data relating to patients, the environment, hospital policy, NR policy, NR context, time of day, patient context, NR rules, NR roles, patient/hospital agreements. This determination may be made solely based on patient priority.

If the determination yields a negative decision (i.e., not to send an indication), then the process proceeds to step 560. In this step, the process determines if this is the last patient for this NR. If not, the process returns to block 520 and repeats the steps of the process for the next patient. If this is the last patient for this notification recipient, the process proceeds to step 570.

If the determination of step 530 yields a positive decision (i.e., to send an indication), the process proceeds to step 540. In step 540, the process formats an indicator based on the patient priority. The indicator may further be responsive to patient data, including but not limited to, nature of the metrics received, patient status, patient image (e.g., facial appearance), caregiver profile, caregiver responsibilities. The indicator so formatted may include, but is not limited to, text, rich text, images (both still and video), icons, audio, synthesized speech, visual indicators (e.g., fixed indicators on walls). For example, an indicator for a nurse may be represented by a patient name, and room number, with the text color coded to indicate severity of the need for care, time of triggering event, and with an icon that indicates nature of the emergency such as an IV icon. The same priority may result in a notification to a physician, but with a different color code, indicating the different nature of the response expected from the physician. In one embodiment, the indicator is a data string which is interpreted by the receiving mobile device. Once the indicator is formatted, the process proceeds to step 550.

In step 550, the process determines if an additional caregiver is to be notified. Additional caregivers are caregivers who do not have formal patient loads in the notification system. These caregivers may be determined by patient context (e.g., if patient context indicates that the patient is not in his or her hospital room), or by patient data. Additional caregivers include, but are not limited to, technicians, nurses in other areas not formally assigned to the patient, relatives. In this step, an indicator is sent to a process to provide the indication. In a preferred embodiment, this process ensures that alerts are correlated and only a single alert is sent.

The process continues with step 560. In this step, the process determines if this is the last patient for this NR. If not, the process returns to block 520 and repeats the steps of the process for the next patient. If this is the last patient for this notification recipient, the process proceeds to block 570.

In step 570, the process orders the indicators formatted previously based on the ordering created in step 440 (FIG. 4). In step 580, the process provides last stage processing of the indicators and transmits them to the notification recipient. Last stage processing customizes the ordered indicators for the NR. This may include, but is not limited to: machine language translation, transcoding, color correction (e.g., to modify colors for those with color perception impairments), voice synthesis. Last stage processing may also include discarding of indicators based on the ordering. For example, if an ordered list contains more than one critical notification, the non-critical notifications may be suppressed. Last stage processing may be responsive to, but is not limited to, mobile device profile, NR preference, NR profile, network capability, information about the set of indicators to be transmitted, hospital policy. In one preferred embodiment, the process transmits the indicators to a notification system or service which then transmits them to the notification recipient.

The process then proceeds to block 590 which indicates the end of the process for this notification recipient. The process returns to block 510 and performs the process for the next NR.

Referring now to FIGS. 6A and 6B, a flowchart illustrates a process for determining a priority associated with a patient care triage methodology according to an embodiment of the invention. More particularly, FIGS. 6A and 6B provide details of step 320 (FIG. 3). It is to be understood that the steps of process 500 are repeated, as indicated in block 510, for each notification recipient. Process 600 begins with block 605 which indicates that the steps of process 600 are to be repeated for each patient associated with a metric received.

In step 610, the process obtains all available metrics related to the patient. These may include the metric received in step 310 (FIG. 3), and may include metrics which were collected at a different time. For example, patient temperature may be received on a periodic basis, e.g., hourly. The metrics obtained in step 610 may include the last measurement made of patient temperature.

In step 615, the process examines the metrics to determine if any warrant emergency action. That is, some metrics may indicate a serious patient problem which requires immediate action on the part of any available caregiver. In step 615, the process evaluates the metrics obtained to determine if this is the case. If it is determined in step 615 that emergency action is required, then in step 620, emergency action is taken. Emergency actions may include, but are not limited to: notification of all personnel, operation of an audible or visible alarm, notification of a designated emergency response team, notification of hospital authority. Once the emergency action is taken, the process proceeds to the next patient.

If an emergency does not exist, in step 625, the process accesses doctor's orders for this patient. In step 630, the process evaluates whether special instructions have been given regarding any of the metrics for this patient. For example, a physician may have left instructions that the patient's blood pressure is normally low, and that no action related to blood pressure is warranted for this patient unless the blood pressure falls below 90/60. In step 635, the process assigns a tentative priority 1 based on the doctor's instructions. Any action indicated in the instructions is also performed. For example, a physician may have left instructions that the family be notified if the patient's blood pressure drops below 70/40.

The process proceeds to step 640, where the metrics are evaluated based on standard medical rules and hospital policy. This may require use of data from a pharmacy, environmental data and so on, as was described above in the information flow of FIG. 2A.

In step 645, the process assigns a second priority based on this evaluation, and takes any action indicated by policy. An example of such an action might be that when a patient's metrics fit the profile of an infections disease, that a process to evaluate whether to report to the Center for Disease Control (CDC) is executed.

The process continues to step 650, where patient records are accessed. Note that while this action is noted in step 650, it may take place earlier in the process for a preferred embodiment.

In step 655, the process determines whether special evaluation is required for this patient. Patient records may indicate a diagnosis which would inform the evaluation of the metrics received. For example, blood sugar metrics for a diabetic patient will be evaluated differently than the same metric from a non-diabetic patient.

If the answer in step 655 is affirmative, the process proceeds to step 660 and makes the evaluations. A third tentative priority is assigned. In step 665, the tentative priorities assigned are compared. If they are all the same, the process proceeds to step 670 where the priority to the patient is assigned, and continues with the next patient. If they are not the same, the process proceeds to step 675.

Steps 675 and 680 are optional. In step 675, the process determines whether the priorities based on one of doctor's orders or special evaluation based on patient record is higher than the standard hospital priority for these metrics. If so, in step 680, the process assigns the higher of the two priorities to the patient, and proceeds to the next patient. However, in a preferred embodiment, differences in tentative priorities are rationalized in step 685.

In step 685, the process applies hospital rules and policies to determine which priority to use. This may include, but is not limited to: applying the highest priority all the time; applying the doctor's priority all the time; applying the special evaluation's priority all the time; applying the priority based on doctors status, applying the priority based on patients condition; applying the priority based on length of physicians care of patient; applying the priority based on hospital insurance practices. In step 690, the process assigns the priority determined in step 685, and proceeds to step 695 and the next patient.

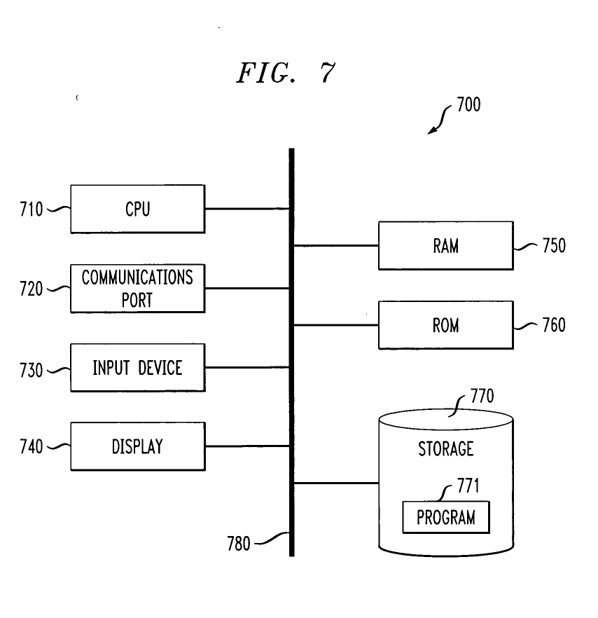

Referring lastly to FIG. 7, a block diagram illustrates a server for use in a patient care triage system, according to an embodiment of the present invention. For example, server 700 can correspond to one or more elements shown in FIG. 2A and/or the server associated with intelligent nursing station 290 in FIG. 2B. More specifically, FIG. 7 illustrates an internal architecture of server 700 according to one embodiment of the invention. Further, a mobile device used by a caregiver to receive notifications may implement the computer architecture of FIG. 7.

As illustrated, server 700 includes CPU (central processing unit) 710 in communication with communication bus 780. CPU 710 may be a Pentium, RISC (reduced instruction set computer), or other type of processor, and is used to execute processor executable process steps so as to control the components of server 700 to provide functionality according to embodiments of the present invention. Also in communication with communication bus 780 is communications port 720. Communication port 720 is used to transmit data to, and to receive data from, devices external to server 700. Communication port 720 is therefore preferably configured with hardware suitable to physically interface with desired external devices and/or network connections.

Input device 730 and display 740 are also in communication with communication bus 780. Any known input device may be used as input device 730 including, for example, a keyboard, mouse, touchpad, voice recognition system, or any combination of these devices. Input device 730 may be used by an entity to input data to server 700. Of course, such information may also be input to server 700 via communications port 720. Commands for controlling operation of server 700 may also be input using input device 730.

Server 700 may output to display 740 which may, for example, be an integral or separate CRT (cathode ray tube) display, flat panel display, or the like. Display 740 is generally used to output graphics, images and/or video, and text to an operator in response to commands issued by CPU 710.

RAM 750 is connected to communication bus 780 to provide CPU 710 with fast data storage and retrieval. In this regard, processor executable process steps being executed by CPU 710 are typically stored temporarily in RAM 750 and executed therefrom by CPU 710. ROM 760 in contrast provides storage from which data can be retrieved but to which data cannot be stored. Accordingly, ROM 760 is used to store invariant process steps and other data, such as basic input/output instructions and data used during system boot-up or to control communication port 720. It should be noted that one or both of RAM 750 and ROM 760 may communicate directly with CPU 710 instead of over communication bus 780.

Data storage device 770 stores, among other data, programs of processor executable process steps for use by CPU 710. For example, CPU 710 executes process steps of program 771 in order to control server 700 in accordance with the present invention. More specifically, the process steps of program 771 may be read from a computer readable medium such as floppy disk, a CD ROM, a DVD ROM, a zip disk, a magnetic tape or a signal encoding the process steps and then stored in data storage device 770. It is to be understood that the present invention is not limited to any specific combination of hardware and software.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1. A method for use in accordance with patient care, the method comprising the steps of:
receiving one or more metrics associated with one or more patients;
determining one or more priorities associated with the one or more patients based at least on the one or more metrics;
determining an ordering of the one or more patients, responsive to the one or more priorities; and
responsive to the ordering of the one or more patients, transmitting an indicator to at least one receiver.

2. The method of claim 1, wherein the step of determining one or more priorities further comprises the steps of:
accessing information about the one or more patients; and
evaluating the one or more metrics responsive to the information.

3. The method of claim 2, wherein the information about the one or more patients is at least one of medical history, an order of a doctor, a threshold for a metric.

4. The method of claim 1, wherein the step of determining one or more priorities further comprises the step of accessing information about a metric.

5. The method of claim 1, further comprising the step of determining a receiver for the indicator of order of the one or more patients.

6. The method of claim 1, wherein the indicator comprises recommended care.

7. The method of claim 1, wherein the step of transmitting an indicator is performed at least one of wirelessly, via Ethernet 802.11, via a cellular network, and via a wide area network.

8. The method of claim 1, wherein the step of transmitting an indicator comprises transmitting an indicator to multiple receivers.

9. Apparatus for use in accordance with patient care, the apparatus comprising:
a memory; and
at least one processor coupled to the memory and operative to: (i) receive one or more metrics associated with one or more patients; (ii) determine one or more priorities associated with the one or more patients based at least on the one or more metrics; (iii) determine an ordering of the one or more patients, responsive to the one or more priorities; and (iv) responsive to the ordering of the one or more patients, transmit an indicator to at least one receiver.

10. The apparatus of claim 9, wherein the operation of determining one or more priorities further comprises accessing information about the one or more patients, and evaluating the one or more metrics responsive to the information.

11. The apparatus of claim 10, wherein the information about the one or more patients is at least one of medical history, an order of a doctor, a threshold for a metric.

12. The apparatus of claim 9, wherein the operation of determining one or more priorities further comprises accessing information about a metric.

13. The apparatus of claim 9, wherein the at least one processor is further operative to determine a receiver for the indicator of order of the one or more patients.

14. The apparatus of claim 9, wherein the indicator comprises recommended care.

15. The apparatus of claim 9, wherein the operation of transmitting an indicator is performed at least one of wirelessly, via Ethernet 802.11, via a cellular network, and via a wide area network..

16. The apparatus of claim 1, wherein the operation of transmitting an indicator comprises transmitting an indicator to multiple receivers.

17. An article of manufacture for use in accordance with patient care, comprising a machine readable medium containing one or more programs which when executed implement the steps of:
receiving one or more metrics associated with one or more patients;
determining one or more priorities associated with the one or more patients based at least on the one or more metrics;
determining an ordering of the one or more patients, responsive to the one or more priorities; and
responsive to the ordering of the one or more patients, transmitting an indicator to at least one receiver.

18. The article of claim 17, wherein the step of determining one or more priorities further comprises the steps of:
accessing information about the one or more patients; and
evaluating the one or more metrics responsive to the information.

19. The article of claim 17, wherein the step of determining one or more priorities further comprises the step of accessing information about a metric.

20. The article of claim 17, further comprising the step of determining a receiver for the indicator of order of the one or more patients.

21. The article of claim 17, wherein the indicator comprises recommended care.

22. The article of claim 17, wherein the step of transmitting an indicator is performed at least one of wirelessly, via Ethernet 802.11, via a cellular network, and via a wide area network.

23. The article of claim 17, wherein the step of transmitting an indicator comprises transmitting an indicator to multiple receivers.

24. A system for use in accordance with patient care, comprising:
one or more input nodes for transmitting information associated with one or more patients;
at least one server operative to: (i) receive at least a portion of the transmitted information from the one or more input nodes; (ii) determine one or more priorities associated with the one or more patients based at least on the received information; (iii) determine an ordering of the one or more patients, responsive to the one or more priorities; and (iv) responsive to the ordering of the one or more patients, transmit indicator information; and
one or more output nodes for receiving at least a portion of the indicator information.

25. The system of claim 24, wherein the one or more input nodes are monitors associated with the one or more patients.

26. The system of claim 24, wherein the one or more output nodes are devices associated with one or more entities associated with patient care.

27. A method for use in accordance with patient care, the method comprising the steps of:
determining one or more priorities associated with one or more patients;
determining an ordering of the one or more patients, responsive to the one or more priorities;
determining a receiver; and
responsive to the ordering of the one or more patients, transmitting an indicator to the receiver.
